(19) United States
(12) Patent Application Publication
(10) Pub. No.: US 2016/0211595 A1
(43) Pub. Date: Jul. 21, 2016

(54) CONNECTOR AND CONNECTOR ASSEMBLY

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventors: JIN-CAI GAO, Wuhan (CN); SHEN-FA TSAI, New Taipei (TW); JIE LI, Wuhan (CN)

(21) Appl. No.: 14/683,813

(22) Filed: Apr. 10, 2015

(30) Foreign Application Priority Data
Jan. 21, 2015 (CN) 201510029172.6

(51) Int. Cl. H01R 12/70; H01R 13/66

(52) U.S. Cl. CPC H01R 12/7076; H01R 13/665

(57) ABSTRACT

A connector includes a main portion. The main portion includes a connecting portion and a supporting portion. The supporting portion is substantially perpendicular to the connecting portion. The supporting portion includes a body. The body enhances mechanical rigidity of the supporting portion. The connector further includes a fixing member. The fixing member is mounted in the main portion. The fixing member is used to fix the main portion to a circuit board. A connector assembly is also provided.

### CROSS-REFERENCE TO RELATED APPLICATIONS

This application claims priority to Chinese Patent Application No. 201510029172.6 filed on Jan. 21, 2015, the contents of which are incorporated by reference herein.

### FIELD

The subject matter herein generally relates to a connector and a connector assembly.

### BACKGROUND

The connector is used for transmitting data between two electronic devices. The connector occupies space on a printed circuit board of the electronic device.

### BRIEF DESCRIPTION OF THE DRAWINGS

Implementations of the present technology will now be described, by way of example only, with reference to the attached figures.

FIG. 1 is an exploded, isometric view of one embodiment of a connector assembly.

FIG. 2 is an exploded, isometric view of a connector for the connector assembly of FIG. 1.

FIG. 3 is an assembled, isometric view of the connector of FIG. 2.

FIG. 4 is a cross-sectional view of the connector of FIG. 3, taken along line IV-IV.

FIG. 5 is an assembled, isometric view of the connector assembly of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “substantially” is defined to be essentially conforming to the particular dimension, shape, or other feature that the term modifies, such that the component need not be exact. For example, “substantially cylindrical” means that the object resembles a cylinder, but can have one or more deviations from a true cylinder. The term “comprising” when utilized, means “including, but not necessarily limited to”; it specifically indicates open-ended inclusion or membership in the so-described combination, group, series and the like.

The present disclosure is described in relation to a connector assembly.

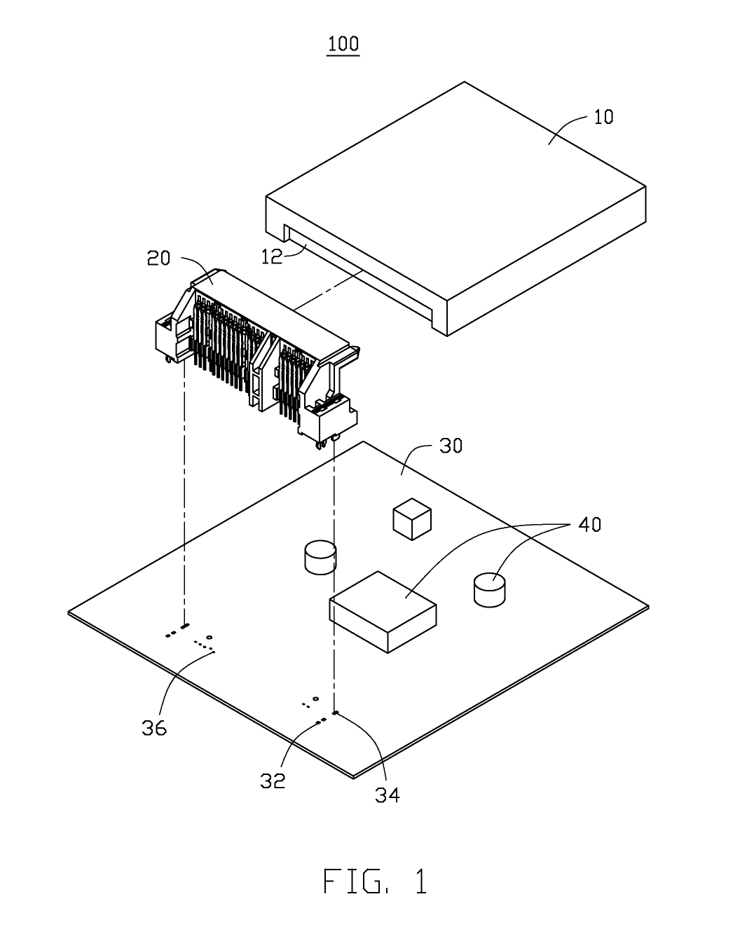

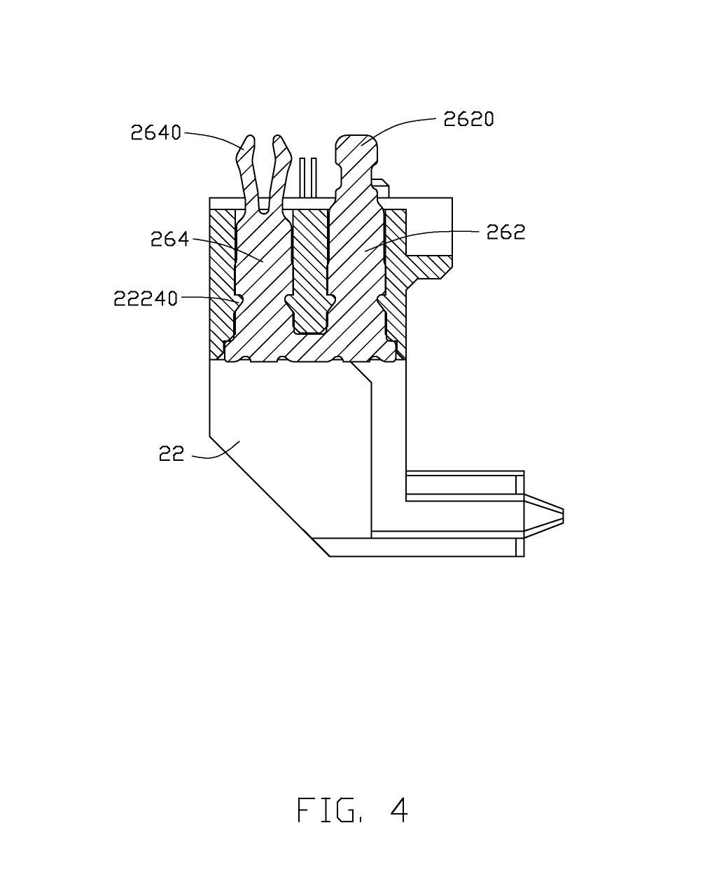

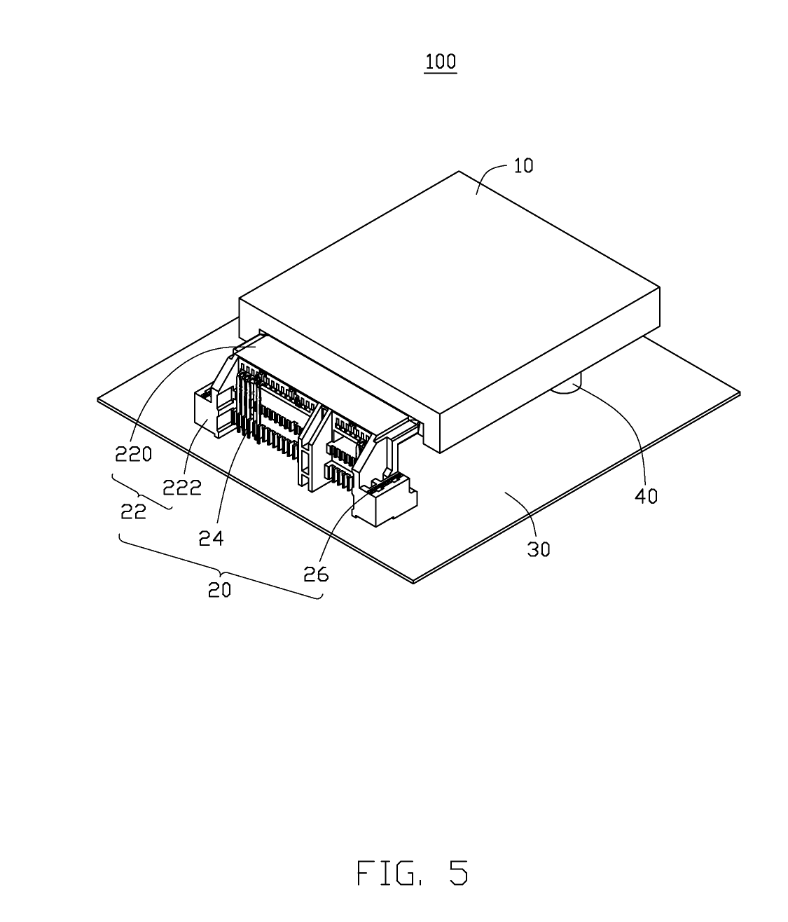

FIGS. 1-5 illustrate one embodiment of a connector assembly 100. The connector assembly 100 includes a storage device 10, a connector 20, and a circuit board 30. The storage device 10 includes an inserting portion 12.

The connector 20 includes a main portion 22, a plurality of pins 24, and two fixing members 26. The main portion 22 includes a connecting portion 220 and a supporting portion 222. The supporting portion 222 extends from the connecting portion 220 and is substantially perpendicular to the connecting portion 220. The connecting portion 220 defines two connecting spaces 2202 and a plurality of mounting holes 2204. The plurality of mounting holes 2204 is aligned in a line on one side of the two connecting spaces 2202. The supporting portion 222 includes a body 2220 and a plurality of arms 2222. Two receiving spaces 2224 are defined in the two sides of the supporting portion 222. The body 2220 includes a plurality of first plates 22202 and a plurality of second plates 22204. The plurality of second plates 22204 is intersected with the plurality of first plates 22202. The plurality of second plates 22204 is substantially perpendicular to the plurality of first plates 22202. The plurality of first plates 22202 and the plurality of second plates 22204 can enhance mechanical rigidity of the supporting portion 222. The plurality of arms 2222 is evenly spaced from each other and is aligned in two rows. An inner surface of each receiving space 2224 includes a plurality of protrusions 22240. Each pin 24 can be substantially L-shaped. Each fixing member 26 includes a fixing piece 262 and a latching portion 264. The fixing piece 262 includes a fixing end 2620. The fixing end 2620 can be substantially hourglass shaped. The latching portion 264 includes two claws 2640. The two claws 2640 can be elastically deformable. The fixing piece 262 and the latching portion 264 define a plurality of grooves 266. The two fixing members 26 are integrally formed with metallic material. In at least one embodiment, each claw 2640 can be substantially rhomboidal. A height of the connecting portion 220 of the connector 20 can be greater than 10 mm. The connector 20 can be a serial advanced technology attachment connector (SATA).

The circuit board 30 defines two fixing holes 32, two latching holes 34, and a plurality of pinholes 36.

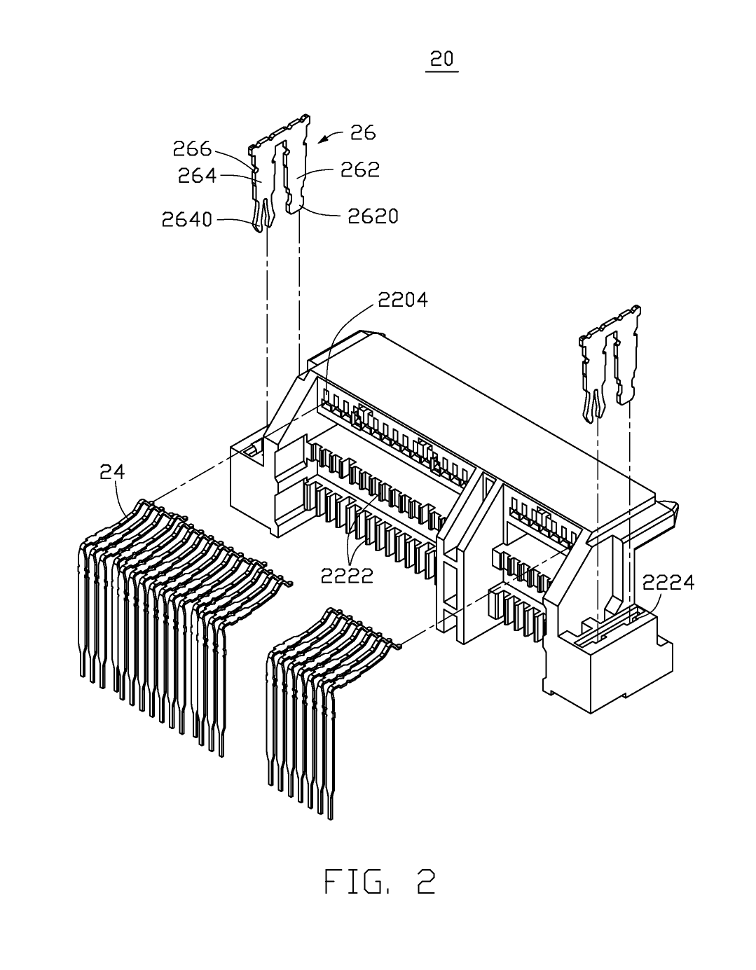

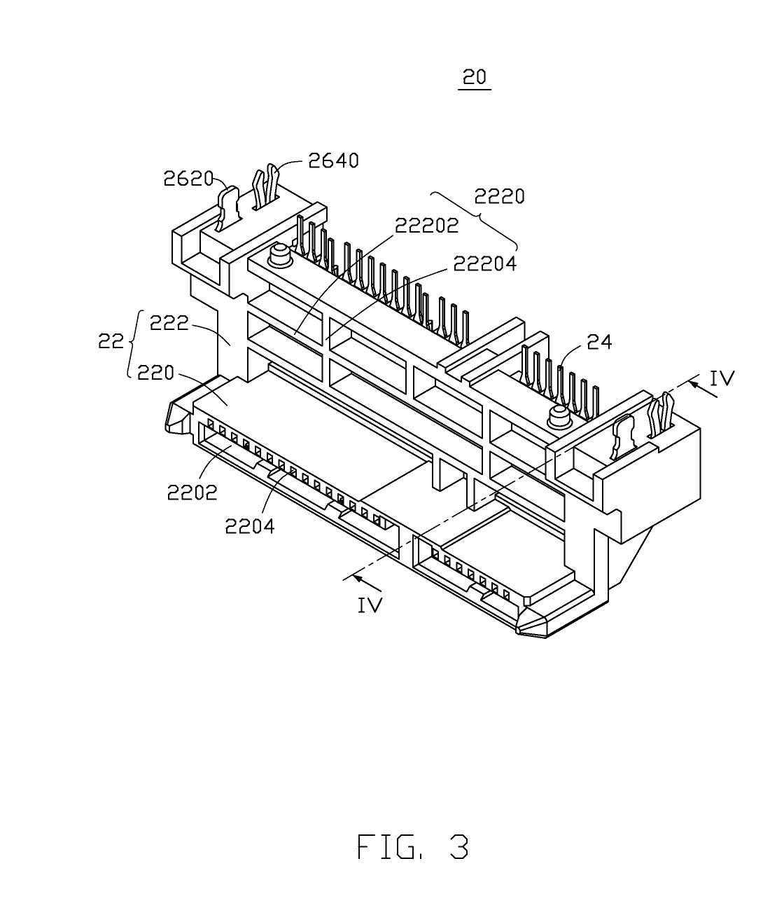

FIGS. 3-5 illustrate an assembled view of the connector assembly 100. One end of each pin 24 is received in each mounting hole 2204. Another end of each pin 24 is engaged with the plurality of arms 2222. The two fixing members 26 are received in the two receiving spaces 2224 (as shown in FIG. 2). The plurality of protrusions 22240 is engaged with the plurality of grooves 266 (as shown in FIG. 2) to fix the two fixing members 26 to the main portion 22. The two fixing members 26 are located on the two sides of the main portion 22. The fixing end 2620 and the two claws 2640 extend out of the main portion 22. The inserting portion 12 (as shown in FIG. 1) is engaged with the two connecting spaces 2202.

The storage device 10 is coupled to the connector 20. The fixing end 2620 is engaged with the fixing holes 32 (as shown in FIG. 1) to fix the connector 20 to the circuit board 30. The two claws 2640 deform and are engaged with the two latching holes 34 (as shown in FIG. 1). The two claws 2640 can reduce the vibration of the connector 20 relative to the circuit board 30. The plurality of pins 24 is engaged with the plurality of pinholes 36 (as shown in FIG. 1). The storage device 10 is substantially parallel to the circuit board 30. The storage device 10 and the circuit board 30 are evenly spaced from each other. A distance between the storage device 10 and the circuit board 30 is substantially equal to a height of the supporting portion 222. A plurality of electronic elements 40 is located on the circuit board 30 and between the storage device 10 and the circuit board 30. In at least one embodiment, the plurality of electronic elements 40 can include a heat dissipation device, a resistor or a capacitor.

The embodiments shown and described above are only examples. Many details are often found in the art such as the other features of a connector assembly. Therefore, many such details are neither shown nor described. Even though numerous characteristics and advantages of the present technology have been set forth in the foregoing description, together with details of the structure and function of the present disclosure, the disclosure is illustrative only, and changes may be made in the details, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A connector comprising:
a main portion comprising a connecting portion and a supporting portion; and
a fixing member;
wherein the connecting portion is configured to engage with a storage device, the fixing member is configured to engage with a circuit board, a height of the supporting portion is configured to prevent the storage device from resisting a plurality of electronic elements located on the circuit board.

2. The connector of claim 1, wherein the fixing member comprises a fixing piece and a latching portion, and the fixing piece and the latching portion are engaged with the circuit board.

3. The connector of claim 2, wherein the main portion defines a receiving space, the receiving space comprises a protrusion, the fixing member defines a groove, and the protrusion is engaged with the groove.

4. The connector of claim 3, wherein the fixing member is integrally formed with metallic material.

5. The connector of claim 1, wherein the supporting portion is substantially perpendicular to the connecting portion

6. The connector of claim 1, wherein a height of the connecting portion of the connector is substantially greater than 10 mm.

7. The connector of claim 1, wherein the connector further comprises a plurality of pins, and the plurality of pins is substantially L-shaped.

8. The connector of claim 7, wherein the connecting portion defines a plurality of mounting holes, and one end of each pin is engaged with each mounting hole.

9. The connector of claim 8, wherein the supporting portion further comprises a plurality of arms, and another end of each pin is engaged with a plurality of arms.

10. The connector of claim 1, wherein the supporting portion comprises a plurality of first plates and a plurality of second plates, the plurality of second plates is intersected with the plurality of first plates, and each second plate is substantially perpendicular to each first plate.

11. A connector assembly comprising:
a storage device;
a circuit board; and
a connector comprising a connecting portion and a supporting portion, and the supporting portion being substantially perpendicular to the connecting portion;
wherein the connecting portion is engaged with the storage device, the supporting portion is fixed on the circuit board, the storage device and the circuit board are spaced from each other, a distance between the storage device and the circuit board is equal to a height of the supporting portion, a plurality of electronic elements is located on the circuit board and between the storage device and the circuit board.

12. The connector assembly of claim 11, wherein the connector further comprises a fixing member, the fixing member comprises a fixing piece and a latching portion, and the fixing piece and the latching portion are engaged with the circuit board.

13. The connector assembly of claim 12, wherein the connector further comprises a main portion, the main portion defines a receiving space, the receiving space comprises a protrusion, the fixing member defines a groove, and the protrusion is engaged with the groove.

14. The connector assembly of claim 13, wherein the fixing member is integrally formed with metallic material.

15. The connector assembly of claim 11, wherein the supporting portion comprises a body, the body comprises a plurality of first plates and a plurality of second plates, the plurality of second plates is intersected with the plurality of first plates, and each second plate is substantially perpendicular to each first plate.

16. The connector assembly of claim 15, wherein a height of the connecting portion of the connector is substantially greater than 10 mm.

17. The connector assembly of claim 11, wherein the connector further comprises a plurality of pins, and the plurality of pins is substantially L-shaped.

18. The connector assembly of claim 17, wherein the connecting portion defines a plurality of mounting holes, and one end of each pin is engaged with each mounting hole.

19. The connector assembly of claim 18, wherein the supporting portion further comprises a plurality of arms, and another end of each pin is engaged with a plurality of arms.

20. A connector comprising:
a main portion having a supporting portion with a first end positionable on a circuit board and a connecting portion with a distal end extending away from a second end of the supporting portion substantially perpendicular to the supporting portion; and
one or more fixing members;
wherein, the one or more fixing members are insertable into one or more receiving spaces defined in the supporting portion of the main portion and are connectable with the circuit board; and
wherein, the distal end of the connecting member is configured to receive an electronic storage device positioning the electronic storage device a preset distance from the circuit board.
